(19) United States
(12) Patent Application Publication
(10) Pub. No.: US 2008/0212213 A1
(43) Pub. Date: Sep. 4, 2008

(54) Light-Shielding Highly Reflective Multilayer Sheet, and Thermoformed Body and Case Using Same

(75) Inventors: Masami Kogure, Chiba (JP); Hiroshi Kawato, Chiba (JP)

Correspondence Address: OBLON, SPIVAK, MCCLELLAND MAIER & NEUSTADT, P.C., 1940 DUKE STREET, ALEXANDRIA, VA, 22314, US

(73) Assignee: IDEMITSU KOSAN CO., LTD., Tokyo (JP)

(21) Appl. No.: 11/569,131

(22) PCT Filed: May 20, 2005
(86) PCT No.: PCT/JP05/09226

§ 371 Date: Nov. 15, 2006

(30) Foreign Application Priority Data
May 20, 2004 (JP) 2004-150028

(51) Int. Cl. G02B 5/08

(52) U.S. Cl. 359/838

(57) ABSTRACT

The present invention provides a light shielding highly reflective laminated sheet, which is a multilayer sheet comprising at least two layers, wherein the total light reflectance (Y value) of the surface of the first layer is 96% or more, the total light reflectance (Y value) of the surface of the outermost layer opposite to the first layer in the multilayer sheet is 30% or less and the total light transmittance of the laminated sheet is 0.3% or less, and a thermomolded article and a case using thereof. In application to light reflection for a liquid crystal backlight unit and the like, the light shielding highly reflective laminated sheet, the thermomolded article and the case using thereof of the present invention can prevent light leakage from a lamp holder portion and also make it possible to integrate a plurality of components of the backlight unit into a single body owing to improved workability of the sheet.

### TECHNICAL FIELD

The present invention relates to a light shielding highly reflective laminated sheet and a thermomolded article and a case thereof. More particularly, the present invention relates to a light shielding highly reflective laminated sheet which is suitable for applications to a reflector of a backlight for a liquid crystal display, a lighting apparatus and a component of a light source such as a fluorescent tube used in a house, various facilities and the like, LED (light-emitting diode), EL (electroluminescence), plasma and laser; and a thermomolded article and a case using the same.

### BACKGROUND ART

Recently, applications of a liquid crystal display device have been remarkably enlarged, and significant growth is expected not only in the conventional use for a screen of a notebook personal computer but also particularly in use for a liquid crystal TV set. The liquid crystal display itself does not emit light. In a small liquid crystal TV set less than 20 inches (51 cm), a liquid crystal monitor of a personal computer, a notebook personal computer and the like, as a light source, there have been adopted an edge-light-type backlight, in which the light source is put by the side of the liquid crystal display and an optical waveguide is used together. A large liquid crystal display (TV and personal computer monitor) of 20 inches (51 cm) or more adopts a direct-underlying-type backlight in which a plurality of fluorescent lamps (cold cathode fluorescent tubes) is provided immediately beneath the liquid crystal screen. Thus the demand for such light source members is expanding.

Each backlight uses fluorescent tubes as the light source and a light reflection film in order to efficiently transmit light to the liquid crystal units. In the edge-type backlight, a foamed polyethylene terephthalate (PET) film or the like is laid under the optical waveguide, while as the reflector of the direct-underlying-type backlight for liquid crystal displays, there have been used a bonded article wherein a foamed PET film or a foamed polypropylene (PP) film and an Al plate are bonded to each other, a supercritical foamed PET sheet and the like. Among them, a bending-processed article of the foamed PET film/Al plate bonded article has been frequently used.

Furthermore, recently, taking advantage of excellent properties of a polycarbonate resin (PC resin), there have been proposed various techniques concerning the light reflection materials (injection-molded articles) such as blending with a particular inorganic filler, blending with other polymers, combining with a foamed body and the like. The advantages of PC resin thermoformed reflector over the currently used bending-processed PET film/Al plate article are that designing shape of the resin is easy compared to metal-working, that the optical design is readily reflected in the resin shape, that the resin is light weight as well as an advantage in the processing cost.

In the direct-underlying-type backlight, since the reflector is used in close contract with a plurality of light sources (cold cathode fluorescent tubes), light resistance for the wavelength of the light source is required. Cold cathode fluorescent tubes emit ultraviolet light having a wavelength of 200 to 400 nm, in addition to light in visible region, which is used as the light source for the liquid crystal, and the ultraviolet light promotes photo-degradation of the reflection members. The resin composing the reflector changes to yellow in color, as the photo-degradation proceeds, and the reflection characteristics of the reflector are deteriorated. For this reason, blending-in type photostabilizers and coating techniques have been proposed in order to impart light resistance to white PET films (for example, see Patent documents 1 to 3).

Since an edge-type backlight comprises a plurality of members such as a lamp house housing an optical waveguide, a reflection film, a frame supporting the optical waveguide and a light shielding tape, simplification and cost reduction are desired for the assembling process and management of components.

The critical major characteristics of the edge-type backlight unit (BLU) include light shielding ability as well as brightness. If the light shielding ability is insufficient in the liquid crystal monitor, light blurring occurs at the ends of the screen. In order to prevent light from being transmitted, a metal-made lamp house has been conventionally used or a light-shielding tape has been attached to each place of the unit where necessary.

Since the conventional edge-type BLU comprises a large number of members and the contrivance for shielding light is complicated as described above, users desire modularization of this unit.

Furthermore, as represented by miniaturization of notebook personal computers, reduction of the thickness of BLU is simultaneously advanced, and securing a high reflectance and sufficient light shielding ability even with the reduced thickness is required for the housing, frame and reflector of these products.

Although the reflection film with a small sheet thickness is excellent in workability such as bending, it has a problem in the light shielding ability due to larger transmittance of light. Meanwhile, the thickness of sheet is large, the light shielding ability is improved but it has a problem of reduced workability.

Moreover, when the thickness becomes smaller, a further higher content of titanium oxide is required in order to obtain higher light shielding ability, and it cannot be prevented that coloring or silver (silver streak) of polycarbonate occurs more frequently in forming process due to reactive groups on surface of titanium oxide even though a stabilizer or the like is added.

With the above background, there has been a situation where a highly reflective material, which has excellent light shielding ability without losing workability, has been strongly desired.

Patent document 1: Japanese Patent Application Laid-Open (JP-A) No. 2001-228313

Patent document 2: Japanese Patent Application Laid-Open (JP-A) No. 2002-40214

Patent document 3: Japanese Patent Application Laid-Open (JP-A) No. 2002-90515

### DISCLOSURE OF THE INVENTION

The present invention, which was achieved in light of the above circumstances, has as an object to provide a light shielding highly reflective laminated sheet having a high reflectance and light shielding ability (that is, a low total light transmittance), a thermomolded article and a case using thereof, and particularly a light shielding highly reflective laminated sheet and a thermomolded article and a case using thereof suitable for modularizing a backlight unit.

The present inventors pursued intensive study and found that the above-mentioned object can be achieved by making the total light reflectance (Y value) of the surface of first layer in multilayer sheet comprising at least two layers be not less than a specific value, the total light reflectance (Y value) of the surface of the outermost layer opposite to the first layer in said multilayer sheet be not more than a specific value and the total light transmittance of the laminated sheet be not more than a specific value. Thus, they reached completion of the present invention.

Namely, the present invention is directed to provide:

(1) a light shielding highly reflective laminated sheet, which is a multilayer sheet comprising at least two layers, wherein the total light reflectance (Y value) of the surface of the first layer is 96% or more, the total light reflectance (Y value) of the surface of the outermost layer opposite to the first layer in said multilayer sheet is 30% or less and the total light transmittance of the laminated sheet is 0.3% or less,
(2) the light shielding highly reflective laminated sheet according to the above (1), wherein the first layer comprises a resin composition containing a polycarbonate-based polymer and titanium oxide,
(3) the light shielding highly reflective laminated sheet according to the above (2), wherein the polycarbonate-based polymer and titanium oxide are contained at a mass ratio of 60:40 to 85:15,
(4) the light shielding highly reflective laminated sheet according to any of the above (1) to (3), wherein when a reflective layer is referred to as the first layer in the multilayer sheet, which comprises three or more layers, the total light reflectance (Y value) of the second layer is 80% or more,
(5) a light shielding highly reflective laminated sheet, wherein at least one layer of the second layer and the layer(s) thereunder comprises a composition containing a recycled material of the first layer or a recycled material of the multilayer highly reflective sheet according to any of the above (1) to (4),
(6) the light shielding highly reflective laminated sheet according to any of the above (1) to (5), wherein the outermost layer opposite to the first layer is a light shielding coating layer with a black paint,
(7) the light shielding highly reflective laminated sheet according to any one of the above (1) to (6), wherein the surface of the first layer is provided with light resistant coating,
(8) the light shielding highly reflective laminated sheet according to the above (1) or any of (4) to (7), wherein the first layer is a foamed material,
(9) the light shielding highly reflective laminated sheet according to any of the above (1) to (8) which has bending hinge part(s),
(10) a thermomolded article formed by using the light shielding highly reflective laminated sheet according to any of the above (1) to (9), and
(11) a case which is assembled by using the light shielding highly reflective laminated sheet according to above (9) with the use of its bending hinge parts, wherein the light shielding highly reflective laminated sheet is adhered to another molded article of a thermoplastic resin or the light shielding highly reflective laminated sheets are adhered together.

### BRIEF DESCRIPTION OF THE DRAWINGS

FIG. 1 is a schematic cross-sectional view of a light shielding highly reflective laminated sheet showing an embodiment of the present invention.

### DESCRIPTION OF THE SYMBOLS

1 Light resistant coating layer
2 Highly reflective layer
3 Recycled layer
4 Highly reflective intermediate layer
5 Light shielding coating layer

### BEST MODE FOR CARRYING OUT THE INVENTION

Hereinafter, the present invention is explained in detail.

### (Light Shielding Highly Reflective Laminated Sheet)

The light shielding highly reflective laminated sheet of the present invention is a multilayer sheet comprising at least two layers, wherein the total light reflectance (Y value) of the surface of the first layer is 96% or more, the total light reflectance (Y value) of the surface of the outermost layer opposite to the first layer in said multilayer sheet is 30% or less and the total light transmittance of the laminated sheet is less than 0.3%.

The total light reflectance (Y value) of the surface of the first layer in the light shielding highly reflective laminated sheet of the present invention is required to be 96% or more, preferably 97% or more and more preferably 98% or more. Here, such a high reflectance can be achieved by adjusting the content of titanium oxide, which is described later.

Moreover, the total light reflectance (Y value) of the surface of the outermost layer opposite to the above-mentioned first layer is required to be 30% or less, preferably 20% or less and more preferably 10% or less. Furthermore, the total light transmittance of the light shielding highly reflective laminated sheet is required to be 0.3% or less, preferably 0.2% or less and more preferably 0.1% or less. Such a sheet with a low light reflectance and an excellent light shielding ability can be obtained by adjusting the light shielding coating layer, which is described later.

Here, if the light reflectance is less than 96% or the light transmittance 0.3% or more, it is difficult to obtain sufficient brightness in the intended use for reflection.

The thickness of the light shielding highly reflective laminated sheet is preferably 0.2 to 2 nm, more preferably 0.3 to 1.8 mm and most preferably 0.4 to 1.5 mm. Here, if the thickness of the sheet is less than 0.2 mm, when a reflector with a large area is thermoformed, drawdown occurs, uneven thickness becomes difficult to prevent, and irregular light reflection is likely caused within the surface. If the thickness of the sheet exceeds 2 mm, the temperature difference among the one surface, inside and the opposite surface is likely to be caused on heating during thermoforming, and a molded article with uniform reflection characteristics is difficult to obtain.

As the reflective layer of the light shielding highly reflective laminated sheet of the present invention, a reflective layer comprising a polycarbonate resin composition containing a polycarbonate-based polymer and titanium oxide is preferably used. As another preferred example, there may be used a white film comprising a thermoplastic film of polyester, polyolefin, polyamide, polyurethane, polyphenylenesulfide or the like.

The polycarbonate-based polymer is preferably a mixture of a polycarbonate-polyorganosiloxane copolymer and a polycarbonate resin (hereinafter, may be referred to as a polycarbonate-based polymer mixture). The polycarbonate-polyorganosiloxane copolymer (hereinafter, may be abbreviated as PC-POS copolymer), which includes various copolymers, preferably comprises a polycarbonate moiety having a repeating unit whose structure is represented by the following general formula (1):

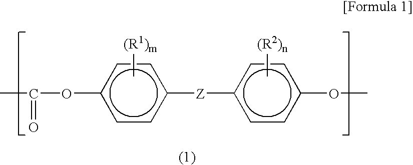

[in the formula, R¹ and R² are individually a halogen atom (for example, chlorine, fluorine, iodine) or an alkyl group having 1 to 8 carbon atoms (for example, methyl group, ethyl group, propyl group, isopropyl group, various butyl groups (n-butyl group, isobutyl group, sec-butyl group, tert-butyl group), various pentyl groups, various hexyl groups, various heptyl groups, various octyl group); m and n are individually an integer of 0 to 4; when m is 2 to 4, R¹ may be the same or different from each other; when n is 2 to 4, R² may be the same or different from each other; and Z represents an alkylene group having 1 to 8 carbon atoms or an alkylidene group having 2 to 8 carbon atoms (for example, methylene group, ethylene group, propylene group, butylene group, pentylene group, hexylene group, ethylidene group, isopropylidene group and the like), a cycloalkylene group having 5 to 15 carbon atoms or a cycloalkylidene group having 5 to 15 carbon atoms (for example, cyclopentylene group, cyclohexylene group, cyclopentylidene group, cyclohexylidene group and the like), a single bond, a —SO₂—, —SO—, —S—, —O— or —CO— bond, or

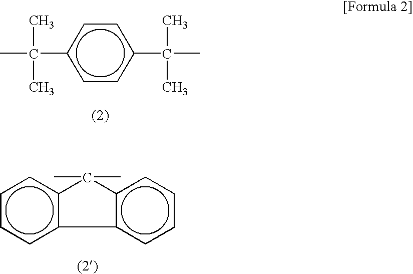

a bond represented by the above formula (2) or formula (2′).]
and a polyorganosiloxane moiety having a repeating unit whose structure is represented by the following general formula (3):

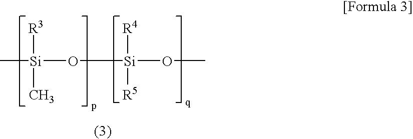

[in the formula, R³, R⁴ and R⁵ are individually a hydrogen atom, an alkyl group having 1 to 5 carbon atoms (for example, methyl group, ethyl group, propyl group, n-butyl group, isobutyl group and the like) or phenyl group; and p and q are individually 0 or an integer of 1 or more, with the proviso that the sum of p and q is an integer of 1 or more.] Here, the degree of polymerization of the polycarbonate moiety is preferably 3 to 100, and the degree of polymerization of polyorganosiloxane moiety is preferably 2 to 500.
The above-mentioned PC-POS copolymer is a block copolymer comprising a polycarbonate moiety having a repeating unit represented by the above general formula (1) and a polyorganosiloxane moiety having a repeating unit represented by the above general formula (3), and the viscosity-averaged molecular weight is preferably 10,000 to 40,000, more preferably 12,000 to 35,000. Such a PC-POS copolymer can be produced, for example, by a method wherein a polycarbonate oligomer (hereinafter abbreviated as a PC oligomer) produced in advance, which will provide the polycarbonate moiety, and a polyorganosiloxane having a reactive group at the terminal, which will provide the polyorganosiloxane moiety, (for example, polydialkylsiloxane such as polydimethylsiloxane (PDMS) and polydiethylsiloxane, polymethylphenylsiloxane and the like) are dissolved in a solvent such as methylene chloride, chlorobenzene and chloroform, and interfacial polycondensation is carried out by adding an aqueous sodium hydroxide solution containing bisphenol using triethylamine, trimethylbenzylammonium chloride or the like as a catalyst. Moreover, one may use a PC-POS copolymer which is produced by the method described in Japanese Patent Application (JP-B) No. S44-30105 and Japanese Patent Application (JP-B) No. S45-20510.

Here, the PC oligomer having the repeating unit represented by the general formula (1) can be readily produced by a solvent method, that is, in the presence of a publicly known acid acceptor and a molecular weight adjusting agent in a solvent such as methylene chloride, by reacting a divalent phenol represented by the following general formula (4):

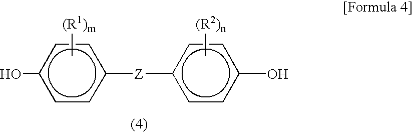

[in the formula, R¹, R², Z, m and n are the same as those of the above general formula (1).] with a carbonate precursor such as phosgene. Namely, the PC oligomer can be produced, for example, by reacting the divalent phenol with a carbonate precursor such as phosgene in a solvent such as methylene chloride in the presence of a publicly known acid acceptor and a molecular weight adjusting agent. Moreover, the PC oligomer can also be produced by ester-exchange reaction of the divalent phenol and a carbonate precursor such as a carbonate ester compound.

The divalent phenol represented by the above general formula (4) includes various phenols. Particularly 2,2-bis(4-hydroxyphenyl)propane [commonly known as bisphenol A] is preferred. As the divalent phenol other than bisphenol A, there may be mentioned, for example, bis(4-hydroxyphenyl)alkanes such as bis(4-hydroxyphenyl)methane, 1,1-bis(4-hydroxyphenyl)ethane and 1,2-bis(4-hydroxyphenyl)ethane, bis(4-hydroxyphenyl)cycloalkanes such as 1,1-bis(4-hydroxyphenyl)cyclohexane and 1,1-bis(4-hydroxyphenyl)cyclodecane, 4,4′-dihydroxydiphenyl, bis(4-hydroxyphenyl)oxide, bis(4-hydroxyphenyl)sulfide, bis(4-hydroxyphenyl)sulfone, bis(4-hydroxyphenyl)sulfoxide, bis(4-hydroxyphenyl)ether and bis(4-hydroxyphenyl)ketone. In addition, the divalent phenol also includes hydroquinone and the like. The above-mentioned divalent phenols may be used alone or as a mixture of two or more kinds thereof.

The carbonate ester compound includes, for example, diaryl carbonate such as diphenyl carbonate, and dialkyl carbonate such as dimethyl carbonate and diethyl carbonate. In producing the polycarbonate by reacting the above-mentioned divalent phenol with the carbonate precursor, a molecular weight adjusting agent may be used if necessary. The molecular weight adjusting agent is not specifically limited and one may use agents used conventionally in producing the polycarbonate. Such an agent includes, for example, a mono-valent phenol such as phenol, p-cresol, p-tert-butylphenol, p-tert-octylphenol, p-cumylphenol, p-nonylphenol and p-dodecylphenol.

In the present invention, the PC oligomer supplied for producing the PC-POS copolymer may be a homopolymer obtained using one kind of the above-mentioned divalent phenol or a copolymer using two or more kinds of the divalent phenols. In addition, the PC oligomer may be a thermoplastic randomly-branched polycarbonate which is obtained by using a multifunctional aromatic compound in combination with the above-mentioned divalent phenol.

Moreover, in order to produce a PC-POS copolymer with an n-hexane-soluble fraction of 1.0% by mass or less, preferably, for example, the content of the polyorganosiloxane in the copolymer is 10% by mass or less, and simultaneously the above-mentioned copolymerization is carried out using the polyorganosiloxane having 100 or more repeating units represented by the general formula (3) with the use of a catalyst such as a tertiary amine at an amount of 5.3×10⁻³ mol/(kg oligomer) or more.

Next, the polycarbonate resin comprising the polycarbonate resin composition used in the present invention may be readily produced, for example, by reacting the divalent phenol with phosgene or the carbonate ester compound. Namely, the polycarbonate resin can be produced, for example, by reacting the divalent phenol with the polycarbonate precursor such as phosgene in the presence of a publicly known acid receptor and a molecular weight adjusting agent in a solvent such as methylene chloride, or by ester-exchange reaction of the divalent phenol and a carbonate precursor such as a carbonate ester compound in the presence or absence of a solvent. Here, the divalent phenol may be the same as or different from the compound represented by the above-mentioned general formula (4).

As the carbonate ester compound and the molecular weight adjusting agent, the same as those mentioned above may be used.

The polycarbonate resin may be a homopolymer obtained using one kind of the above-mentioned divalent phenol or may be a copolymer obtained using two or more kinds of the divalent phenols. Moreover, the polycarbonate resin may be a thermoplastic randomly-branched polycarbonate resin which is obtained by using a multifunctional aromatic compound in combination with the above-mentioned divalent phenol. The multifunctional aromatic compound, which is commonly called a branching agent, specifically includes 1,1,1-tris(4-hydroxyphenyl)ethane, α,α′,α″-tris(4-hydroxyphenyl)-1,3,5-triisopropylbeiizene, 1-[α-methyl-α-(4′-hydroxyphenyl)ethyl]-4-[α′,α′-bis(4″-hydroxyphenyl)ethyl]benzene, phloroglucine, trimellitic acid, isatin bis(o-cresol) and the like.

The polycarbonate resin has a viscosity-averaged molecular weight preferably in the range of 13,000 to 30,000, particularly preferably in the range of 15,000 to 25,000 with respect to mechanical strength, particularly Izod impact strength, formability and other physical properties. Incidentally, the viscosity-averaged molecular weight (Mv) is a value calculated based on the equation, [η]=1.23×10⁻⁵ Mv^{0.83}, using the intrinsic viscosity [η] determined from the viscosities of methylene chloride solutions of the resin measured at 20° C. with an Ubbelohde viscometer.

The polycarbonate resins having these characteristics are commercially available, for example, as an aromatic polycarbonate resin such as Tarflon FN3000A, FN2500A, FN2200A, FN1900A, FN1700A and FN1500A (trade name, produced by Idemitsu Petrochemical Co., Ltd.).

Based on 100 parts by mass of the total of each component in the above-mentioned polycarbonate-based polymer mixture plus titanium oxide, the blending ratio of the PC-POS in the polycarbonate-based polymer mixture is 5 to 85 parts by mass, preferably 10 to 58 parts by mass, and the blending ratio of the polycarbonate resin is 0 to 80 parts by mass, preferably 10 to 75 parts by mass. If the blending ratio of the PC-POS is less than 5 parts by mass, the polyorganosiloxane is not sufficiently dispersed, resulting in difficulty in attaining sufficient flame resistance. On the contrary, the blending ratios of the PC-POS and the polycarbonate resin are in the preferred range, a resin with excellent flame resistance can be provided. The content of the polyorganosiloxane moiety in the PC-POS may be selected accordingly depending on the level of flame resistance required for the finally obtained resin composition. The ratio of the polyorganosiloxane moiety in the PC-POS is preferably 0.3 to 10% by mass, more preferably 0.5 to 5% by mass based on the total amount of the PC-POS and the polycarbonate resin. If the ratio of the polyorganosiloxane moiety in the PC-POS is less than 0.3% by mass, a sufficient oxygen index is not obtained, and therefore the desired flame resistance may not be attained. If the ratio of the polyorganosiloxane moiety in the PC-POS exceeds 10% by mass, the heat resistance of the resin is likely to be significantly deteriorated, and the cost of the resin is also raised. When the blending ratio of the polyorganosiloxane moiety is in the preferable range, a resin having a more suitable oxygen index and therefore excellent flame resistance can be obtained. Here, the “polyorganosiloxane” does not include the polyorganosiloxane components contained in the organosiloxane, which is described later.

The titanium oxide used in the reflective layer of the light shielding highly reflective laminated sheet of the present invention is used in the form of fine powder for the purpose of giving high reflectance and low transparency, that is, high light shielding ability to the polycarbonate-based polymer mixture. The finely powdered titanium oxide in various particle size fractions may be produced either by chlorine method or by sulfuric acid method. The titanium oxide used in the present invention, although it may be either of rutile-type or of anatase-type, is preferably rutile-type with respect to heat stability, weather resistance and other physical properties. Moreover, the shape of the fine powdery particle is not specifically limited, and any of scale-like, spherical and amorphous powders may be selected to use where appropriate.

The titanium oxide is preferably surface-treated with a hydrated oxide of aluminum and/or silicon, an amine compound, a polyol compound or the like. Such a treatment improves, in addition to homogeneity of dispersion of titanium oxide in the polycarbonate resin composition and stability in the dispersion state, the affinity with a flame retardant further added, and improvement of such properties is preferred for producing a homogeneous composition. Examples of the hydrated oxide of aluminum, the hydrated oxide of silicon, the amine compound and the polyol compound as referred to here may be hydrated alumina, hydrated silica, triethanolamine and trimethylolethane, respectively. The treatment method in the above-mentioned surface-treatment is not limited, and any method may be adopted where appropriate. The amount of the surface-treating agent applied to the surface of the titanium oxide particles, which is not specifically limited, is preferably approximately 0.1 to 10.0% by mass with respect to titanium oxide, considering the light reflectance of titanium oxide and the formability of the polycarbonate resin composition.

Though the particle size of the above-mentioned titanium oxide powder is not specifically limited, the titanium oxide with an average particle size of approximately 0.1 to 0.5 μm is suitable to efficiently bring out the above-mentioned effect. The amount of the titanium oxide to be blended in the polycarbonate resin composition relating to the present invention is 8 to 50 parts by mass, preferably 15 to 40 parts by mass, with respect to 100 parts by mass of the total of each component in the above-mentioned polycarbonate-based polymer mixture plus titanium oxide. If the blending amount is less than 8 parts by mass, the light shielding ability is insufficient and, undesirably, the light reflectance decreases significantly. If the blending amount exceeds 50 parts by mass, the pelletization by kneading and extrusion becomes difficult, the forming process of the resin also becomes difficult, and the occurrence of silver in the formed product tends to increase. Since light shielding ability and high light reflectance are required for the reflector and the reflection frame used in the backlight particularly for application to liquid crystal TV sets, monitors and the like, the blending amount of titanium oxide is preferably in the range of 20 to 35 parts by mass.

The surface acid amount of titanium oxide used in the present invention is preferably 10 μmol/g or more, and the surface base amount is preferably 10 μmol/g or more. If the surface acid amount is smaller than 10 μmol/g, or if the surface base amount is smaller than 10 μmol/g, dispersion of titanium oxide becomes poor and the brightness of the formed product may not be sufficiently high because the reactivity of titanium oxide with the organosiloxane compound, which is a stabilizer, becomes lower. The surface acid amount of titanium oxide is more preferably 15 μmol/g or more, further preferably 16 μmol/g or more, and the surface base amount of titanium oxide is more preferably 20 μmol/g or more, further preferably 25 μmol/g or more.

When polytetrafluoroethylene (hereinafter, may be abbreviated as “PTFE”) having fibril-forming ability is blended to the polycarbonate resin composition relating to the present invention, preventive effect for melt-dripping and high flame resistance can be imparted to the resin composition. The average molecular weight of PTFE is preferably 500,000 or more, more preferably in the range of 500,000 to 10,000,000, further preferably in the range of 1,000,000 to 10,000,000. The amount of PTFE is preferably 0 to 1.0 part by mass, more preferably 0.1 to 0.5 part by mass with respect to 100 parts by mass of the total of the polycarbonate-based polymer mixture and titanium oxide. If the amount of PTFE exceeds 1.0 part by mass, not only the impact resistance and appearance of the formed product are adversely affected, but also stable production of pellets may be impaired due to ripple of discharge of the strand during kneading and extrusion. When the amount of PTFE is the above-mentioned range, suitable preventive effect for melt-dripping is attained and pellets with excellent flame resistance are obtained.

The polytetrafluoroethylene (PTFE) having fibril-forming ability is not specifically limited, and there may be used, for example, a PTFE classified as Type III according to the ASTM standard. Specifically, this type of PTFE includes Teflon 6-J (trade name, produced by DuPont-Mitsui Fluorochemicals Co., Ltd.), Polyflon D-1 and Polyflon F-103 (trade name, produced by Daikin Industries, Ltd.), and the like. Examples of PTFE other than those of Type III include Algoflon F5 (trade name, produced by Montefluos S.p.A.), Polyflon MPA FA-100 (trade name, produced by Daikin Industries, Ltd.), and the like. Two or more kinds of these PTFEs may be used in combination.

The above-mentioned PTFE having fibril-forming ability may be produced, for example, by polymerizing tetrafluoroethylene at a temperature of 0 to 200° C., preferably 20 to 100° C., under a pressure of 0.007 to 0.7 MPa in an aqueous solvent in the presence of sodium, potassium or ammonium peroxydisulfide.

In the polycarbonate resin composition relating to the present invention, organosiloxane is preferably blended for preventing deterioration of the resin and of maintaining the characteristics such as mechanical strength, stability and heat resistance of the resin. Specifically the organosiloxane includes an alkyl hydrogen silicone and an alkoxysilicone.

The alkyl hydrogen silicone includes, for example, methyl hydrogen silicone, ethyl hydrogen silicone and the like. The alkoxysilicone includes, for example, methoxysilicone, ethoxysilicone and the like. The especially preferred alkoxysilicone is specifically a silicone compound containing an alkoxysilyl group in which an alkoxy group bonds directly or via a divalent hydrocarbon group to a silicon atom. Such an alkoxysilicone compound includes, for example, a linear, cyclic, net or partially-branched linear organopolysiloxane, and a linear organopolysiloxane is particularly preferred. More specifically is preferred an organopolysiloxane having a molecular structure in which an alkoxy group is bonded to a silicon main chain via a methylene chain.

As such an organosiloxane, there may be suitably used SH1107, SR2402, BY16-160, BY16-161, BY16-160E, BY16-161E and the like produced by Dow Corning Toray Co., Ltd.

The preferred amount of the organosiloxane to be added is, although it depends on the amount of titanium oxide added, in the range of 0.05 to 2.0 parts by mass with respect to 100 parts by mass of the total of each composition in the polycarbonate-based polymer mixture plus titanium oxide. If this amount is less than 0.05 parts by mass, deterioration of the polycarbonate resin occurs, and the molecular weight of the resin is likely to be decreased. If the amount exceeds 2.0 parts by mass, it is economically disadvantageous because no significant improvement in effect is observed in spite of such a high addition amount, and the appearance of the product is likely to be impaired due to occurrence of silver on the surface of the formed material.

To the polycarbonate resin composition relating to the present invention, in addition to the above-mentioned polycarbonate-based polymer mixture, titanium oxide, PTFE and organosiloxane, there may be added various inorganic fillers, additives, other synthetic resins, elastomers and the like, as needed, in such a range that the purposes of the present invention may not be impaired. Firstly, as the above-mentioned inorganic filler blended for the purpose of improving mechanical strength or durability or of increasing the weight of the polycarbonate resin composition, there may be mentioned, for example, glass fiber (GF), carbon fiber, glass bead, glass flake, carbon black, calcium sulfate, calcium carbonate, calcium silicate, alumina, silica, asbestos, talc, clay, mica, quartz powder and the like. In addition, as the above-mentioned additive, there may be mentioned, for example, an antioxidant such as a hindered phenol-type antioxidant and a hindered amine-type antioxidant, an ultraviolet absorber such as a benzotriazole-type ultraviolet absorber or a benzophenone-type ultraviolet absorber, an external lubricant such as an aliphatic carboxylate ester-type lubricant, a paraffinic lubricant, silicon oil and polyethylene wax, a mold-releasing agent, an antistatic agent, a coloring agent and the like. As the other synthetic resin, there may be mentioned various kinds of resins including polyethylene, polypropylene, polystyrene, AS resin (acrylonitrile-styrene copolymer), ABS resin (acrylonitrile-butadiene-stylene copolymer), poly(methyl methacrylate) and the like. As the elastomer, there may be mentioned isobutylene-isoprene rubber, styrene-butadiene rubber and styrene-propylene rubber, an acrylic elastomer and the like.

Next, a white film comprising the above-mentioned thermoplastic film is suitably used for the reflective layer of the light shielding highly reflective laminated sheet of the present invention. The white film is not specifically limited, and one may use any film if it is a film with an apparent whiteness. For example, there may be mentioned a film in which an organic or inorganic dye, fine particles or the like is (are) added to the thermoplastic plastic film; a film with fine bubbles generated inside which is formed by the method wherein a resin composition composing the film is blended with a resin immiscible with the resin composition and/or organic or inorganic particles, the mixture is melted and extruded, and then the extruded material is stretched in at least one direction; and a foamed film prepared by injecting a gas such as carbon dioxide gas to generate bubbles through extrusion. Particularly, in application to the present invention, for further improving reflectance and brightness, is preferred the film with fine bubbles generated inside which is formed by the method wherein a resin composition composing the film is blended with a resin immiscible with the resin composition and/or organic or inorganic particles, the mixture is melted and extruded, and then the extruded material is stretched in at least one direction.

The thermoplastic resin composing the film is not specifically limited if it can form a film by melting and extruding. There may be mentioned, for example, polyester, polyolefin, polyamide, polyurethane, polyphenylenesulfide and the like, among which, polyester and polyolefin are preferable. Polyester is especially preferable in terms of excellence in dimensional stability and mechanical characteristics, lack of absorption in the range of visible light and other properties.

A specific example of polyester includes polyethylene terephthalate (hereinafter, abbreviated as PET), polyethylene 2,6-naphthalenedicarboxylate (hereinafter, abbreviated as PEN), polypropylene terephthalate, polybutylene terephthalate, poly-1,4-cyclohexylenedimethylene terephthalate and the like. Although, needless to say, these polyesters may be a homopolymer or a copolymer, a homopolymer is preferred. As a copolymerization component in the case of the copolymer, there may be mentioned an aromatic dicarboxylic acid, an aliphatic dicarboxylic acid, alicyclic dicarboxylic acid and a diol component having 2 to 15 carbon atoms. As such compounds, there may be mentioned, for example, isophthalic acid, adipic acid, sebacic acid, phthalic acid, isophthalic acid containing a sulfonate salt moiety and a compound forming an ester therewith, diethylene glycol, triethylene glycol, neopentylglycol and polyalkylene glycol having a molecular weight of 400 to 20,000 and the like.

In order to whiten polyester used as a base material, there may be a method in which a white dye or a white pigment is added, a method in which fine bubbles are incorporated into the inside of the film as mentioned above and the like. In order to attain the effect of the present invention more dominantly, the method in which bubbles are incorporated into the inside of the film is preferable. The method for incorporating such fine bubbles includes, (1) a method in which a foaming agent is added to the polyester and foaming is caused by the heat during extrusion or film-forming or by chemical decomposition, (2) a method in which foaming is caused by adding a gas like carbon dioxide gas or a vaporizable substance during or after extrusion, (3) a method in which a thermoplastic resin immiscible with the polyester is added to the polyester, the mixture is melted and extruded and then the extruded material is stretched along one axis or two axes and (4) a method in which organic or inorganic fine particles are added to the polyester, the mixture is melted and extruded, and the extruded material is stretched along one axis or two axes. In the present invention, it is preferable to enlarge the reflecting interface area by forming fine bubbles. In this respect, the above method (3) or (4) is preferably used.

The bubble size (cross sectional area in the depth direction) obtained by the above-mentioned method is 0.5 to 50 μm², preferably 1 to 30 μm² in terms of improving brightness. Moreover, the cross sectional shape of the bubble may be circular or elliptic. A structure in which at least one bubble is present in any plane from the top surface to the bottom surface of the film is particularly preferable. Namely, the most preferred is an embodiment wherein, when the film is used as a reflector, all the incident light, which enters through the surface into the inside of the film serving as the reflector, should be reflected by the bubbles inside the film. In practice, a part of the light passes through the inside of the film, and this portion contributes to light loss. In order to reduce the light loss, it is required to provide a layer having a total light reflectance (Y value) of 30% or less as the surface of the outermost layer opposite to the first layer (the bubble-formed film) in the multilayer sheet as described later.

The specific gravity, which is used as a measure of the bubble content, of such a white film containing bubbles is preferably not less than 0.1 and not more than 1.3. If the specific gravity is less than 0.1, there may occur problems that the film has insufficient mechanical strength and that the film is frangible, causing inconvenience in handling. On the other hand, if the specific gravity exceeds 1.3, the reflectance tends to decrease, causing insufficient brightness due to too low bubble content. Moreover, when polyester is used as the thermoplastic resin comprising the film, the lower limit of the specific gravity is preferably 0.4. If the specific gravity is less than 0.4, breakage may frequently occur during film forming, because the bubble content is too high.

Furthermore, a polyolefin may be used as the white sheet. Among polyolefins, a polypropylene resin having excellent heat stability at a high temperature is preferred. When polypropylene resin is used as a base material to be whitened, the white sheet is produced by a method wherein an inorganic filler and a stretch auxiliary agent are added to the polypropylene resin, they are mixed to prepare a resin composition, the resultant composition is formed to an unstretched sheet by a melt extrusion forming or another formation method, and then the obtained unstretched sheet is stretched along one axis or two axes.

The resultant porous white sheet has uniform reflectance independent of the position within the sheet, and the productivity of this sheet is excellent.

The polypropylene resin used in the present invention is not specifically limited if it is produced by homopolymerizing propylene by a publicly known method. Further, the stereo-regularity of side chains in the polymer is not specifically limited and any of isotactic, syndiotactic and atactic polypropylene may be used. These polypropylenes may be used alone, or as a mixture of two or more kinds of them. The melt index (hereinafter, referred to as MI) of the polypropylene resin is generally 0.1 g/10 min to 5 g/10 min, preferably 0.2 g/10 min to 3 g/10 mm.

Generally, the Vicat softening point of the polypropylene resin is preferably 130° C. or more, and more preferably 140° C. or more.

As the inorganic filler, there may be used at least one substance selected from barium sulfate, calcium carbonate and titanium oxide. Taking into consideration of the reflectance of the porous resin sheet to be obtained, either barium sulfate or calcium carbonate is suitably used, and more preferably barium sulfate is used. As barium sulfate, precipitated barium sulfate, in which the polypropylene resin is well dispersed and mixed, is preferable. Furthermore, since the particle size of the inorganic filler influences the surface state, reflectance, productivity and mechanical strength of the porous resin sheet to be obtained, the average particle size of the inorganic filler is preferably approximately 0.1 to 7 μm, further preferably 0.3 to 5 μm.

The blending ratio of the polypropylene resin and the inorganic filler influences the light reflectance of the porous sheet to be obtained. The smaller the amount of the inorganic filler added, the lower the porosity of the obtained porous sheet, and vice versa. If the porous sheet has a low porosity, the light amount reflected at the interface between the resin layer and an air layer is decreased, and a high light reflectance cannot be attained. Therefore, a porous sheet suitable for a light reflection body should have a moderate porosity and a high light reflectance. Moreover, if the amount of the inorganic filler added is large, although the porosity and therefore the light reflectance of the porous sheet are increased, the productivity and the strength of the porous sheet are decreased. Considering all such issues together, the blending ratio of the polypropylene resin and the inorganic filler is preferably 25 to 40% by weight of the polypropylene resin and 75 to 60% by weight of the inorganic filler, and more preferably 25 to 35% by weight of the polypropylene resin and 75 to 65% by weight of the inorganic filler.

Since the stretch auxiliary agent used in the present invention enhances a stretching ability of the resin composition. Further the agent can improve the productivity through preventing breakage during stretching of the porous resin sheet, and it also has a function of facilitating cracks to occur between the resin and the inorganic filler during stretching. Accordingly, the stretching auxiliary agent can impart a high reflectance to the porous resin sheet to be obtained and also reduce variation of the reflectance depending on the position within the sheet to 3% or less. As a result, the light reflection body of the present invention exhibits uniform light reflection without irregularity in brightness. As an example of the stretching auxiliary agent having such characteristics, there may be mentioned an ester of a fatty acid and glycerin. A preferred fatty acid is octadecanoic acid, hexadecanoic acid, octadecenoic acid, octadecadienoic acid, hydroxyoctadecanoic acid, hydroxyhexadecanoic acid or the like. The ester of such a fatty acid and glycerin includes a monoester, a diester and a triester. These esters may be used alone or as a mixture thereof. A triester is more preferred and, in particular, a dehydrated castor oil composed of mainly octadecadienoic acid triglyceride and a hardened castor oil composed of mainly hydroxyoctadecanoic acid triglyceride is suitably used because these are unlikely to cause bleeding. These stretching auxiliary agents may be used alone, or two or more of them may be used as a mixture. The amount of the stretching auxiliary agent added is preferably 0.01 to 10 parts by weight with respect to 100 parts by weight of the total of the polypropylene resin and the inorganic filler.

If the thickness of the porous resin sheet is thin, the light transmittance tends to increase, reducing the reflectance. Meanwhile, a thick porous resin sheet is undesirable because the productivity of the sheet is reduced, although the reflectance is improved. Therefore, in consideration of the reflectance and the productivity, the thickness of the porous resin sheet of the present invention used as a light reflection body is preferably 50 to 300 μm, more preferably 70 to 200 μm.

The light shielding coating layer comprising the light shielding highly reflective sheet of the present invention is provided on the surface (the outermost layer) opposite to the reflective layer in order to block the visible light or to suppress the transmission of the visible light. As the light shielding coating layer, a coating layer in which a black pigment is dispersed in a base agent (a binder) may be used.

As the base agent, an acrylurethane-based resin is typically used. As the black pigment, there may be used a pigment selected from carbon black, lamp black, horn black, black lead, iron black, aniline black, cyanine black, and others such as a mixed-color coloring material of dyes or pigments. Carbon black is especially preferred.

The thickness of the light shielding coating layer is preferably 1 to 30 μm, more preferably 1 to 20 μm, and further preferably 2 to 20 μm. If the thickness of the light shielding coating layer is less than 1 μm, the transmission of visible light may not be sufficiently suppressed, while the light shielding coating layer having a thickness exceeding 30 μm is undesired because drying efficiency is reduced in forming the light shielding coating layer by a coating method, requiring a long drying time.

As such a light shielding coating layer, for example, there may be suitably used a commercially available paint “SY915 Cake Ink JK” produced by Tokyo Printing ink Mfg. Co., Ltd., a paint “A mixture of Acrythane TSR-5 and Acrythane Curing Agent at the ratio of 10:1” produced by Dai Nippon Toryo Co., Ltd. and the like.

In the light shielding highly reflective sheet of the present invention, a light resistant coating may be provided on the surface of the first layer of the reflective layer if necessary. The light resistant coating has a function to block or absorb ultraviolet light. The blockage or absorption of ultraviolet light can be realized by incorporating at least one kind of agent selected from photostabilizers and ultraviolet absorbers into the light resistant coating layer.

As the photostabilizer or the ultraviolet absorber, there may be preferably used organic compounds such as hindered amine-type compounds, salicylic acid-type compounds, benzophenone-type compounds, benzotriazole-type compounds, benzoxazinone-type compounds, cyanoacrylate-type compounds, triazine-type compounds, benzoate-type compounds, oxanilide-type compounds, organo-nickel compounds and the like, or inorganic compound-based materials such as sol and gel.

The hindered amine-type compound includes bis(2,2,6,6-tetramethyl-4-piperidyl) sebacate, polycondensate of dimethyl succinate and 1-(2-hydroxyethyl)-4-hydroxy-2,2,6,6-tetramethylpiperidine, tetrakis(2,2,6,6-tetramethyl-4-piperidyl) 1,2,3,4-butanetetracarboxylate, 2,2,6,6-tetramethyl-4-piperidyl benzoate, bis(1,2,2,6,6-pentamethyl-4-piperidyl) 2-(3,5-di-t-butyl-4-hydroxybenzyl)-2-n-butylmalonate, bis(N-methyl-2,2,6,6-tetramethyl-4-piperidyl)sebacate, 1,1′-(1,2-ethanediyl)bis(3,3,5,5-tetramethylpiperazinone) and the like.

The salicylic acid-type compound includes p-t-butylphenyl salicylate, p-octylphenyl salicylate and the like.

The benzophenone-type compound includes 2-hydroxy-4-n-octoxybenzophenone, 2-hydroxy-4-methoxybenzophenone, 2-hydroxy-4-ethoxybenzophenone, 2,4-dihydroxybenzophenone, 2-hydroxy-4-methoxy-5-sulfobenzophenone, 2,2′,4,4′-tetrahydroxybenzophenone, 2,2′-dihydroxy-4-methoxybenzophenone, 2,2′-dihydroxy-4,4′-dimethoxybenzophenone, bis(2-methoxy-4-hydroxy-5-benzoylphenyl)methane and the like.

The benzotriazole-type compound includes 2-(2′-hydroxy-5′-methylphenyl)benzotriazole, 2-(2′-hydroxy-5′-t-butylphenyl)benzotriazole, 2-(2′-hydroxy-3′,5′-di-t-butylphenyl)benzotriazole, 2-(2′-hydroxy-3′-t-butyl-5′-methylphenyl)-5-chlorobenzotriazole, 2-(2′-hydroxy-3′,5′-di-t-butylphenyl)-5-chlorobenzotriazole, 2-(2′-hydroxy-5′-t-octylphenyl)benzotriazole, 2-(2′-hydroxy-3′,5′-di-t-amylphenyl)benzotriazole, 2,2′-methylenebis[4-(1,1,3,3-tetramethylbutyl)-6-(2H-benzotriazol-2-yl)phenol], 2-(2′-hydroxy-5′-methacryloxyphenyl)-2H-benzotriazole, 2-[2′-hydroxy-3′-(3″,4″,5″,6″-tetrahydrophthalimidomethyl)-5′-methylphenyl]benzotriazole, 2-(2′-hydroxy-5′-acryloyloxyethylphenyl)-2H-benzotriazole, 2-(2′-hydroxy-5′-methacryloxyethylphenyl)-2H-benzotriazole, 2-(2′-hydroxy-3′-t-butyl-5′-acryloylethylphenyl)-5-chloro-2H-benzotriazole and the like.

The cyanoacrylate-type compound includes ethyl 2-cyano-3,3-diphenylacrylate, 2-ethylhexyl 2-cyano-3,3-diphenylacrylate, 1,3-bis[2′-cyano-3′,3′-diphenylacryloyloxy]-2,2-bis[(2′-cyano-3′,3′-diphenylacryloyloxy)methyl]propane and the like.

The triazine-type compound includes 2-(4,6-diphenyl-1,3,5-triazin-2-yl)-5-hexyloxyphenlol, 2-[4,6-bis(2,4-dimethylphenyl)-1,3,5-triazin-2-yl)-5-hexyloxyphenol and the like.

The benzoate-type compound includes 2,4-di-butylphenyl 3′,5′-di-t-butyl-4′-hydroxybenzoate, resorcinol monobenzoate, methyl o-benzoylbenzoate and the like. The oxanilide-type compound includes 2-ethoxy-2′-ethyloxanilide and the like. The organo-nickel compound includes nickel bis(octylphenyl)sulfide, [2,2′-thiobis(4-t-octylphenolato)](n-butylamine)nickel, nickel complex of monoethyl 3,5-di-t-butyl-4-hydroxybenzylphosphate, nickel dibutyldithiocarbamate and the like.

The benzoxazinone-type compound includes 2,2′-(1,4-phenylene)bis[4H-3,1-benzoxazin-4-one] and the like.

The malonic ester-type compound includes dimethyl [(4-methoxyphenyl)methylene]propanedioate and the like.

Among the above-mentioned compounds, hindered amine-type compounds, benzophenone-type compounds and benzotriazole-type compounds are preferable.

In order to facilitate the formation of the light resistant coating layer containing the photostabilizer and/or ultraviolet absorber in the present invention, it is preferred to use the photostabilizer and/or ultraviolet absorber as a mixture with another resin component if necessary. Namely, it is preferred to use, as the coating solution, a mixed solution in which the resin composition and the photostabilizer and/or ultraviolet absorber are dissolved in a solvent, a liquid prepared by dissolving either one of the resin component and the photostabilizer and/or ultraviolet absorber and dispersing the other in a solvent, and a mixed liquid prepared by dissolving or dispersing the resin component and the photostabilizer and/or ultraviolet absorber separately in each solvent in advance and then mixing the resultant liquids. In this case, as a solvent, one or more kinds of liquid selected from water and organic solvents may be used appropriately. Moreover, a copolymer of the photostabilizer component and/or ultraviolet absorber component and the resin component may be preferably used, as prepared, as the coating solution.

The resin component which is mixed or copolymerized with the photostabilizer and/or ultraviolet absorber is not specifically limited. There may be used, for example, polyester-based resin, polyurethane-based resin, acrylic resin, methacrylic resin, polyamide-based resin, polyethylene-based resin, polypropylene-based resin, poly(vinyl chloride)-based resin, poly(vinylidene chloride)-based resin, polystyrene-based resin, poly(vinyl acetate)-based resin, fluorine-containing compound-based resin and the like. These resins may be used singly or in combination of two or more kinds of them. Among the above-mentioned resin components, the acrylic resin and methacrylic resin are preferable.

For the light resistant coating layer provided to the light shielding highly reflective laminated sheet of the present invention, acrylic resin or methacrylic resin prepared by copolymerizing the photostabilizer component and/or ultraviolet absorber component is preferably used. In copolymerization, it is preferred that a polymerizable photostabilizer component and/or ultraviolet absorber component is copolymerized with an acrylic monomer component or a methacrylic monomer component.

As the polymerizable photostabilizer component or ultraviolet absorber component, there may be preferably used one or more compounds selected from hindered amine-type compounds, benzotriazole-type compounds, benzophenone-type compounds, benzoxazinone-type compounds, cyanoacrylate-type compounds, triazine-type compounds and malonic ester-type compounds. The polymerizable photostabilizer component and ultraviolet absorber component may be a compound which contains, in its basic skeletal structure, hindered amine, benzotriazole, benzophenone, benzoxazinone, cyanoacrylate, triazine or malonic ester and has a polymerizable unsaturated bond. Usually, such a compound is an acrylic or methacrylic monomer compound which has a functional group derived from the above-mentioned compound having light absorbing ability or ultraviolet absorbing ability in the side chain.

As the polymerizable hindered amine-type compound, there may be mentioned bis(2,2,6,6-tetramethyl-5-acryloyloxyethylphenyl-4-piperidyl)sebacate, polycondensate of dimethyl succinate and 1-(2-hydroxyethyl)-4-hydroxy-2,2,6,6-tetramethyl-5-(acryloyloxyethylphenyl)piperidine, bis(2,2,6,6-tetramethyl-5-methacryloxyethylphenyl-4-piperidyl)sebacate, polycondensate of dimethyl succinate and 1-(2-hydroxyethyl)-4-hydroxy-2,2,6,6-tetramethyl-5-(methacryloxyethylphenyl)piperidine, bis(2,2,6,6-tetramethyl-5-acryloylethlphenyl-4-piperidyl)sebacate, polycondensate of dimethyl succinate and 1-(2-hydroxyethyl)-4-hydroxy-2,2,6,6-tetramethyl-5-(acryloylethylphenyl)piperidine and the like.

As the polymerizable benzotriazole-type compound, there may be mentioned 2-(2′-hydroxy-5′-acryloyloxyethylphenyl)-2H-benzotriazole, 2-(2′-hydroxy-5′-methacryloxyethylphenyl)-2H-benzotriazole, 2-(2′-hydroxy-3′-t-butyl-5′-acryloylethylphenyl)-5-chloro-2H-benzotriazole and the like.

As the polymerizable benzophenone-type compound, there may be mentioned 2-hydroxy-4-methoxy-5-(acryloyloxyethylphenyl)benzophenone, 2,2′,4,4′-tetrahydroxy-5-(acryloyloxyethylphenyl)benzophenone, 2,2′-dihydroxy-4-ethoxy-5-(acryloyloxyethylphenyl)benzophenone, 2,2′-dihydroxy-4,4′-dimethoxy-5-(acryloyloxyethylphenyl)benzophenone, 2-hydroxy-4-methoxy-5-(methacryloxyethylphenyl)benzophenone, 2,2′,4,4′-tetrahydroxy-5-(methacryloxyethylphenyl)benzophenone, 2,2′-dihydroxy-4-methoxy-5-(acryloylethylphenyl)benzophenone, 2,2′-dihydroxy-4,4′-dimethoxy-5-(acryloylethylphenyl)benzophenone and the like.

As the acrylate monomer component or the metharylate. monomer component or the oligomer component thereof which is copolymerized with these polymerizable photostabilizer component and/or ultraviolet absorber component, there may be mentioned alkyl acrylate, alkyl methacrylate (wherein the alkyl group is methyl group, ethyl group, n-propyl group, isopropyl group, n-butyl group, isobutyl group, t-butyl group, 2-ethylhexyl group, lauryl group, stearyl group, cyclohexyl group or the like) and a monomer having a crosslinkable functional group (for example, a monomer having carboxyl group, methylol group, acid anhydride group, sulfonic acid group, amide group, methylolated amide group, amino group, alkylolated amino group, hydroxyl group, epoxy group or the like). Moreover, these components may be copolymerized with acrylonitrile, methacrylonitrile, styrene, butyl vinyl ether, maleic acid, itaconic acid and dialkyl ester thereof, methyl vinyl ketone, vinyl chloride, vinylidene chloride, vinyl acetate, vinylpyridine, vinylpyrrolidone, alkoxysilane having a vinyl group, unsaturated polyester or the like.

The copolymerization ratio of these polymerizable photo stabilizer components and/or ultraviolet absorber component and the monomer(s) to be copolymerized is not specifically limited. However, the ratio of the polymerizable photostabilizer component and/or ultraviolet absorber component is preferably 10% by mass or more, more preferably 20% by mass or more, and further preferably 35% by mass or more. A polymer may be prepared by polymerizing only the polymerizable photostabilizer component and/or ultraviolet absorber component without using the above-mentioned monomers. The molecular weight of these polymers is, although not specifically limited, typically 5,000 or more, preferably 10,000 or more, and more preferably 20,000 or more, from the point of the toughness of the coating layer. These polymers are used in a state where they are dissolved or dispersed in an organic solvent, water, or a mixture of an organic solvent and water. Besides the above-mentioned copolymers, a commercially available hybrid-type photostable polymer may also be used. Moreover, there may be used “UWR” produced by Nippon Shokubai Co., Ltd. which contains a copolymer of an acrylic monomer, a photostabilizer and an ultraviolet absorber as the active ingredient; “HC-935UE” produced by Ipposha Oil Industries Co., Ltd. which contains a copolymer of an acryl monomer and an ultraviolet absorber as the active ingredient; and the like.

The thickness of the light resistant coating layer is, although not specifically limited, in general, preferably 0.5 to 20 μm.

The light shielding highly reflective laminated sheet of the present invention may be provided with an intermediate layer, which is the second layer or thereunder and not the outermost layer, if necessary. For this intermediate layer, one may use a recycled material (an edge slit material, a material with poor appearance and a residual material in thermoforming) of said laminated sheet. When the above-mentioned intermediate layer is provided as the second layer, its total light reflectance (Y value) is preferably 80% or more.

Moreover, there may be provided a highly reflective layer having the total light reflectance (Y value) of 96% or more, which is the same value as that of the first layer, as the intermediary third layer.

Furthermore, the configuration of the light shielding highly reflective laminated sheet of the present invention is explained based on the drawing.

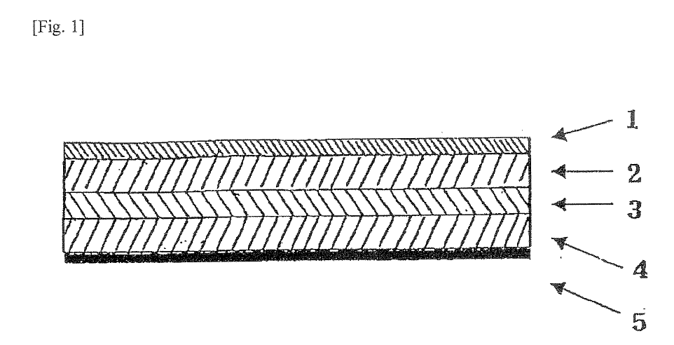

FIG. 1 is a schematic cross-sectional view of the light shielding highly reflective laminated sheet showing one embodiment of the present invention, wherein 1 shows a light resistant coating layer, 2 a highly reflective layer, 3 a recycled layer, 4 a high reflection intermediate layer and 5 a light shielding coating layer.

The light shielding highly reflective laminated sheet shown in FIG. 1 comprises the light resistant coating layer 1 (provided if necessary) which has a function to block or absorb ultraviolet light; the first layer, which is the highly reflective layer 2 having the total light reflectance of 96% or more; the intermediary second layer, which is the recycled layer 3 (a reflective layer provided if necessary) composed of the above-mentioned recycled material and has the total light reflectance of 80% or more; the intermediary third layer, which is the highly reflective intermediate layer 4 (provided if necessary) having the total light reflectance of 96% or more, which is the same value as that of the first layer; and the outermost layer opposite to the light resistant coating layer 1 or the highly reflective layer 2, which is the light shielding coating layer 5 blocking visible light or suppressing transmission of visible light, having the total light reflectance of 30% or less. The total light transmittance of this embodiment is less than 0.3% as the laminated sheet.

Moreover, the light shielding highly reflective laminated sheet of the present invention may have the bending hinge part, which is not shown in FIG. 1, to facilitate the assembly of the formed product if necessary.

### (Manufacturing Method of the Sheet)

The base sheet comprising the light shielding highly reflective laminated sheet of the present invention is formed as follows. At first, the above-mentioned polycarbonate resin composition is dried usually at 120 to 140° C. for approximately 2 to 10 hr, and then extruded using an extruder equipped with a vacuum unit under the conditions of the die temperature of about 200 to 260° C. and the roll temperature of 120 to 180° C. to form a sheet. Here, the drying condition of the PC resin composition is preferably at a temperature of 130 to 140° C. for 2 to 10 hr, more preferably at a temperature of 130 to 140° C. for 4 to 10 hr.

The drying of the PC resin composition may be carried out, for example, under an ordinary heated air atmosphere, under a dry air atmosphere or in vacuum. The drying enables eliminating most of moisture contained in the source material and volatile reaction by-products generated in compounding.

Moreover, an extruder for sheet forming is required to be equipped with a vapor-removing unit. The vapor-removing unit can evacuate the PC resin composition in a melt state to a pressure lower than the atmospheric pressure, and it reduces the pressure during extrusion to 8.0 kPa (60 mmHg) or less, preferably to 4.0 kPa (30 mmHg) or less. The vapor-removing under reduced pressure can remove moisture remaining in the PC resin composition and volatile reaction by-products generated in compounding, and volatile reaction by-products secondarily generated during the extrusion forming as well.

Here, if the drying of the polycarbonate resin composition or the vapor-removing during the extrusion forming is insufficient, foaming of the base sheet or surface roughness occurs, thereby likely decreasing the reflectance or causing uneven reflection.

Moreover, the die temperature in the sheet forming is typically 200 to 260° C., preferably 200 to 250° C., and further preferably 200 to 240° C. If the die temperature exceeds 260° C., the draw resonance phenomenon likely occurs, resulting in uneven thickness in the width direction (especially at the ends) and in the length direction, thereby likely causing uneven reflection as the sheet alone and as the surface of the thermoformed product thereof. This is a phenomenon which likely occurs in the sheet forming when a large amount of titanium oxide powder is contained in the polycarbonate resin composition relating to the present invention.

Furthermore, the chill roll temperature in sheet forming is typically 120 to 180° C., and preferably 120 to 170° C. Here, if the temperature of all the rolls is less than 120° C., sizing between the nip rolls is difficult due to the high rigidity of the material in a melt state, and the homogeneity of the surface state in the width and length directions may not be maintained, thereby likely causing uneven reflection as the sheet alone and as the surface of the thermoformed product thereof.

On the other hand, if the temperature of all the rolls exceeds 170° C., surface adhesion, unevenness in peeling or warping of the sheet occurs due to adhesion or adherence of the sheet to the rolls, and therefore a base sheet having homogeneous reflection characteristics cannot be obtained.

### (Forming Method of the Light Resistant Coating Layer on the Sheet)

Although the above-mentioned light resistant coating layer containing the photostabilizer and/or ultraviolet absorber may be directly provided on the above-mentioned base sheet, when adhesion is poor, it is preferred to provide the light resistant coating layer after the surface of the base sheet is subjected to corona discharge treatment or undercoating treatment. The undercoating treatment may be carried out either by a method (in-line coating method) in which a undercoating layer is provided in the step of producing the above-mentioned sheet or by a method (off-line coating method) in which the undercoat is provided in a separate coating step after producing the base sheet. The material used for the undercoating treatment is not specifically limited, and any appropriate material may be selected. For example, there may be suitably used copolymerized polyester resin, polyurethane resin, acrylic resin, methacrylic resin, various type of coupling agents and the like.

In providing the light resistant coating layer on the base sheet, a coating solution may be applied onto the sheet by any method. For example, there may be gravure coating, roll coating, spin coating, reverse coating, bar coating, screen coating, blade coating, air knife coating, dipping and the like. After coating, the resultant light resistant coating layer is dried, for example, in a hot air oven at typically 80 to 120° C. When the light resistant coating layer is cured after coating, the publicly known method may be adopted. For example, there may be applied heat curing method, a method of curing with an activating radiation such as ultraviolet light, electron beam, nuclear radiation and the like, and a combination thereof. At this time, a curing agent such as a crosslinking agent is preferably used together. The coating solution for forming the light resistant coating layer may be either applied during the production of the base sheet (in-line coating) or applied on the base sheet wherein orientation of crystals has been completed (off-line coating).

### (Forming Method of the Light Shielding Coating Layer on the Sheet)

In the present invention, the light shielding coating layer is formed on the sheet formed by extrusion according to the above-mentioned production method of the sheet. As the forming method, the sheet is coated with a light shielding solution by direct gravure rolling or by atomizing in a mist state, spraying or the like so that the dry thickness may be 1 to 30 μm, and then the resultant film is dried in a hot air oven at approximately 80 to 120° C. Alternatively, coextrusion with the light shielding resin is also effective.

### (Forming Method of the Intermediate Layer)

In the present invention, as the intermediate layer, there may be used, for example, a recycled material (an edge slit material, a material with poor appearance, a residual material in thermoforming and a substandard material) of the present laminated sheet and the like. Coextrusion forming is typical as the forming method of the intermediate layer.

As the coextrusion method, each resin to be laminated is extruded with separate extruders under the same conditions as those of the aforementioned forming method of the sheet, forming a multilayer configuration. As the major coextrusion method, there may be mentioned two methods; a feed block method in which each resin is laminated in front of the die and a multimanifold method in which each resin is laminated within the die, although these methods do not specifically restrict the production method of the multilayer sheet in the present invention.

### (Thermoforming)

The highly reflective laminated sheet of the present invention has thermoformable property and therefore provides thermoformed bodies such as the reflector having a reflection surface in accordance with the number and shape of the light sources under a particular thermoforming condition. The sheet heating temperature in thermoforming (sheet surface temperature) is typically 160 to 200° C., preferably 170 to 200° C. The average draw ratio is typically 1.1 to 2 times, preferably 1.2 to 1.8 times.

The thermoforming in the present invention, which is not specifically limited, includes press forming, vacuum forming, vacuum pressure forming, hot plate forming, wave plate forming and the like. Moreover, as a forming method which is generally called a vacuum forming, there may be mentioned drape forming method, matched die method, pressure-bubble plug assist vacuum forming method, plug assist method, vacuum snap-back method, air slip forming method, trapped sheet contact heating-pressure forming method, simple pressure forming method and the like. The vacuum forming may be carried out under an appropriate pressure of 1 MPa or less.

Here, if the sheet heating temperature is less than 160° C., thermoforming is difficult, while if the temperature exceeds 200° C., uneven roughness likely occurs on the surface. In addition, the average draw ratio is lees than 1.2 times, it is difficult to design the reflector in accordance with the shape of the light source, while if the ratio exceeds 2 times, nonuniformity in thickness of the thermoformed product becomes large and the reflectance irregularity likely occurs. The sheet used for thermoforming is preferably used after pre-drying, which prevents the foaming phenomenon caused by adsorbed moisture. The drying condition at this time is suitably 120 to 140° C. for 2 to 10 hr.

### (Formed Products)

By adjusting the above-mentioned sheet production conditions and thermoforming conditions appropriately, one can obtain a formed product in which the variation in thickness of the light reflection surface of the formed product is 0.2 nm or less. If the variation in thickness of the reflection surface exceeds 0.2 mm, it is unlikely to attain uniform surface reflection characteristics. The shape of formed product may be suitably selected in accordance with the shape, number and characteristics of the light sources. For example, in the case of the reflector for the direct-underlying-type backlight, one may select the shape disclosed in Japanese Patent Application Laid-Open (JP-A) No. 2000-260213, Japanese Patent Application Laid-Open (JP-A) No. 2000-356959, Japanese Patent Application Laid-Open (JP-A) No. 2001-297613 and Japanese Patent Application Laid-Open (JP-A) No. 2002-32029.

The present invention also provides the above-mentioned thermomolded article formed by using the aforementioned light shielding highly reflective laminated sheet of the present invention or the case in which said light shielding highly reflective laminated sheets are adhered together.

As the above-mentioned adhesion in this case, there may be adopted a method such as ultrasonic adhesion, laser adhesion, hot press adhesion and the like.

### EXAMPLES

Hereinafter, examples of the present invention are explained with reference to comparative examples, but the present invention is not limited by any of these examples.

### Production Example 1

### Production of PC-PDMS Copolymer

### (1) Production of a PC Oligomer

A sodium hydroxide aqueous solution of bisphenol A was prepared by dissolving 60 kg of bisphenol A in 400 liters of a 5% by mass sodium hydroxide aqueous solution. Then, the sodium hydroxide aqueous solution of bisphenol A with the temperature maintained room temperature and methylene chloride were introduced at a flow rate of 138 liters/hr and 69 liters/hr, respectively, through an orifice plate into a tubular reactor having an inner diameter of 10 nm and a tube length of 10 m, and concurrently phosgene was blown in a parallel flow at a flow rate of 10.7 kg/hr to carry out reaction continuously for 3 hr. The tubular reactor used here was made of a double tube, and cooling water was passed through the jacket to maintain the discharge temperature of the reaction solution at 25° C. The pH value of the discharged solution was adjusted to 10 to 11.

By allowing the resultant reaction solution to stand, the aqueous phase was separated and removed and the methylene chloride phase (220 liters) was collected to obtain a PC oligomer (concentration: 317 g/liter). The degree of polymerization of the resultant PC oligomer was 2 to 4, and the concentration of the chloroformate group was 0.7 N.

### (2) Production of Reactive PDMS

1,483 g of octamethylcyclotetrasiloxane, 96 g of 1,1,3,3-tetramethyldisiloxane and 35 g of 86% sulfuric acid were mixed and this mixture was stirred at room temperature for 17 hr. Then, the oily phase was separated, and 25 g of sodium hydrogen carbonate was added to this phase, and the resultant mixture was stirred for 1 hr. After the mixture was filtered, low-boiling materials were removed by vacuum-distillation at 150° C. at 3 Torr (400 Pa) to obtain an oil.

To a mixture of 60 g of 2-allylphenol and 0.0014 g of platinum as platinum chloride-alcoholate complex, 294 g of the oil obtained above was added at 90° C. This mixture was stirred for 3 hr while maintaining the temperature between 90° C. and 115° C. The product was extracted with methylene chloride, the extract was washed with 80% aqueous methanol three times to remove an excessive amount of 2-allylphenol. The resultant product solution was dried over anhydrous sodium sulfate, and the solvent was distilled off in vacuum while the temperature raised up to 115° C. The resultant reactive PDMS (polydimethylsiloxane) having terminal phenol groups was found to have 30 repeating units of dimethylsilanoxy group, which was determined by NMR measurement.

### (3) Production of PC-PDMS Copolymer

To 2 liters of methylene chloride, 138 g of the reactive PDMS obtained in the above (2) was dissolved, and this solution was mixed with 10 liters of the PC oligomer obtained in the above (1). To the resultant solution were added a solution prepared by dissolving 26 g of sodium hydroxide in 1 liter of water and 5.7 mL of triethylamine, and the mixture was stirred at 500 rpm at room temperature for 1 hr to proceed reaction.

After the reaction was completed, to the above reaction system were added a solution prepared by dissolving 600 g of bisphenol A in 5 liters of a 5.2% by mass sodium hydroxide aqueous solution, 8 liters of methylene chloride and 96 g of p-tert-butylphenol, and the resultant mixture was stirred at 500 rpm at room temperature for 2 hr to proceed reaction.

After the reaction was completed, 5 liters of methylene chloride was added to the resultant solution, and the resultant solution was sequentially subjected to water-washing with 5 liters of water, alkali-washing with 5 liters of 0.03 N sodium hydroxide aqueous solution, acid-washing with 5 liters of 0.2 N hydrochloric acid and water-washing with 5 liters of water twice. Finally methylene chloride was removed from the solution to obtain a flaky PC-PDMS copolymer. The resultant PC-PDMS copolymer was dried in vacuum at 120° C. for 24 hr. The viscosity-averaged molecular weight was 17,000 and the PDMS content was 3.0% by mass. Here, the viscosity-averaged molecular weight (Mv) and the PDMS content were determined by the following methods.

### (1) Viscosity-Averaged Molecular Weight (Mv)

The intrinsic viscosity [η] was determined from the viscosities of methylene chloride solutions containing the copolymer measured at 20° C. using an Ubbelohde viscometer, and the viscosity-averaged molecular weight was calculated by the following equation:

[η]=1.23×10⁻⁵ Mv^{0.83}

### (2) PDMS Content

The PDMS content was determined based on the intensity ratio of the peak assigned to the methyl group in the isopropyl group of bisphenol A observed at 1.7 ppm to the peak assigned to the methyl group of dimethylsiloxane observed at 0.2 ppm in the ¹H-NMR spectrum.

### Production Example 2

### Production of Polycarbonate-Based Resin Composition-1 (PC1)

With respect to 100 parts by mass of the total of 46% by mass of the polycarbonate-poly(dimethylsiloxane) copolymer obtained in the Production Example 1 (PC-PDMS, Mv=17,000, PDMS content=3.0% by mass), 24% by mass of bisphenol A-type linear polycarbonate 1 (produced by Idemitsu Petrochemical Co., Ltd., trade name: Tarflon FN1500, Mv=14,500) and 30% by mass of titanium oxide powder (produced by ISHIHARA SANGYO KAISHA, LTD., trade name: PF726), 1.2 parts by mass of organosiloxane (produced by Dow Corning Toray Co., Ltd., trade name: BY16-161), 0.3 part by mass of polytetrafluoroethylene (PTFE, produced by ASAHI GLASS CO., LTD. trade name: CD076) and 0.1 part by mass of triphenylphosphine (produced by Johoku Chemical Co., Ltd., trade name: JC263) were mixed. The resultant mixture was melted and kneaded in a two-axis extruder to obtain a polycarbonate-based resin composition.

### Production Example 3

### Production of Polycarbonate-Based Resin Composition-2 (PC2)

With respect to 100 parts by mass of the total of 59% by mass of the polycarbonate-polydimethylsiloxane copolymer obtained in the Production Example 1 (PC-PDMS, Mv=17,000, PDMS content=3.0% by mass), 31% by mass of bisphenol A-type linear polycarbonate 1 (produced by Idemitsu Petrochemical Co., Ltd., trade name: Tarflon FN 1500, Mv=14,500) and 10% by mass of titanium oxide powder (produced by ISHIHARA SANGYO KAISHA, LTD., trade name: PF726), 0.8 part by mass of organosiloxane (produced by Dow Corning Toray Co., Ltd., trade name: BY16-161), 0.3 part by mass of polytetrafluoroethylene (PTFE, produced by ASAHI GLASS CO., LTD. trade name: CD076) and 0.1 part by mass of triphenylphosphine (produced by Johoku Chemical Co., Ltd., trade name: JC263) were mixed. To the resultant mixture, 1 part by mass of an ultraviolet absorber (produced by Chemipro Kasei Kaisha, Ltd., trade name: Chemisorb 79) was further added, and the mixture was melted and kneaded (at 280° C. and 300 rpm) in a two-axis extruder (Toshiba Machine Co., Ltd. TEM35B) to obtain a polycarbonate-based resin composition.

### Production Example 4

### Production of Polycarbonate-Based Resin Composition-3 (PC3)

A laminated body before the coating treatment for light shielding described in the below Example 3 was pulverized by a pulverizer to a size feedable to an extruder (average particle size: 2 to 3 mm), and the resultant powders was dry-blended at the ratio of 30% by mass with the polycarbonate-based resin composition-2 obtained in the Production Example 3.

### Production Example 5

### Production of Polycarbonate-Based Resin Composition-4 (PC4)

To 100 parts by mass of bisphenol A-type linear polycarbonate 1 (produced by Idemitsu Petrochemical Co., Ltd., trade name: Tarflon A2200, Mv=21,600), 1 part by mass of carbon black (Pigmocolor 1603F04) produced by Daito Kasei Kogyo Co., Ltd. was mixed. The resultant mixture was melted and kneaded in a two-axis extruder to obtain a black-colored polycarbonate-based resin composition.

### [Coating Agent 1]

Paint “SY915 Cake Ink JK” produced by Tokyo Printing Ink Mfg. Co., Ltd.

### [Coating Agent 2]

Paint “A mixture of Acrythane TSR-5 and Acrythane Curing Agent at the mass ratio of 10:1” produced by Dai Nippon Toryo Co., Ltd.

### [Coating Agent 3]

“UWR UW-G12” produced by Nippon Shokubai Co., Ltd.

### [Coating Agent 4]

A coating agent for adhering layers together by applying between the layers of the multilayer sheet: Used for adhering the first layer and the third layer together by a procedure wherein a mixture of dry laminating agent “Dickdry LX90” and “KW75” produced by Dainippon Ink and Chemicals Inc. at the ratio of 9:1 was dissolved in ethyl acetate to prepare a 20% solution, and the resultant solution was applied onto the surface opposite to the light shielding surface of the third layer at the coating thickness of 10 μm.

### Example 1

The polycarbonate-based composition-1 (PC-1 pellet) obtained in the Production Example 2 was dried in a hot air oven at 140° C. for 4 hr. This material was extruded in the horizontal direction with an extruding apparatus having a 65 μmmΦ-single axis extruder equipped with a vapor-removing unit, a gear pump and a coat hanger die of 60 cm width, and then sheet-formed with a longitudinal three-chill-roll system to obtain a sheet having a thickness of 800 μm.

Here, the cylinder temperature was 250 to 260° C., the vapor-removing pressure was 1.3 kPa (10 mmHg), the die temperature was 210° C., the temperatures of the roll No. 1, No. 2 and No. 3 were 120° C., 150° C. and 170° C., respectively, and the extrusion amount 30 kg/hr.

Coating agent 1 was applied onto the side opposite to the reflection surface (as the outermost layer) of the sheet using a bar coater so that its dry thickness may be 20 μm. The resultant sheet was dried in a hot air oven at 100° C. for 30 min.

### Example 2

Polycarbonate-based composition-1 (PC1 pellet) obtained in Production Example 2 and polycarbonate-based composition-2 (PC2 pellet) obtained in Production Example 3 were dried in a hot air oven at 140° C. for 4 hr. The resultant materials were coextruded in the horizontal direction by using individual extruding apparatuses having a 65 mmΦ-single axis extruder equipped with a vapor-removing unit for the polycarbonate composition-2 or a 30 mmΦ-single axis extruder with a vapor-removing unit for the polycarbonate composition-1, a feed block and a coat hanger die of 60 cm width. The resultant material was sheet-formed with a longitudinal three-chill-roll system to obtain a sheet of the total thickness of 800 μm in which the thickness of the polycarbonate composition-1 layer was 100 μm and the thickness of the polycarbonate composition-2 layer was 700 μm.

Here, the cylinder temperature was 250 to 260° C., the vapor-removing pressure was 1.3 kPa (10 mmHg), the die temperature was 260° C., the temperature of the roll No. 1, No. 2 and No. 3 were 120° C., 150° C. and 170° C., respectively, and the extrusion amounts were 7 kg/hr for polycarbonate composition-1 and 43 kg/hr for polycarbonate composition-2.

Coating agent 1 was applied onto the PC2 side (as the outermost layer) of the above-mentioned sheet using a bar coater so that its dry thickness may be 20 μm, and then the resultant sheet was dried in a hot air oven at 100° C. for 30 min.

### Example 3

Polycarbonate-based composition-1 (PC1 pellet) obtained in Production Example 2 and polycarbonate-based composition-2 (PC2 pellet) obtained in Production Example 3 were dried in a hot air oven at 140° C. for 4 hr. The resultant materials were coextruded as three layers with two kinds in the horizontal direction by using individual extruding apparatuses having a 65 mmΦ-single axis extruder equipped with a vapor-removing unit for polycarbonate composition-2 or a 30 mmΦ-single axis extruder equipped with a vapor-removing unit for polycarbonate composition-1, a feed block and a coat hanger die of 60 cm width, and then the resultant material was sheet-formed with a longitudinal three-chill-roll system to obtain a sheet of the total thickness of 800 μm consisting of a polycarbonate composition-1 layer of 200 μm thickness, a polycarbonate composition-2 layer of 400 μm thickness and another polycarbonate composition-1 layer of 200 μm thickness.

Here, the cylinder temperature was 250 to 260° C., the vapor-removing pressure was 1.3 kPa (10 mmHg), the die temperature was 260° C., the temperatures of the roll No. 1, No. 2 and No. 3 were 120° C., 150° C. and 170° C., respectively, and the extrusion amount was 25 kg/hr for polycarbonate composition-1 and 25 kg/hr for polycarbonate composition-2.

Coating agent 1 was applied onto the side of polycarbonate composition-1 (as the outermost layer) of the above-mentioned sheet using a bar coater so that its dry thickness may be 20 μm, and then the resultant sheet was dried in a hot air oven at 100° C. for 30 min.

### Example 4

Polycarbonate composition-2 (PC2) was sheet-formed in the same way as Example 1, and the resultant sheet was coated with coating agent 2 to form a coating film of 10 μm thickness as the outermost layer.

### Example 5

By the same method as that of Example 3 except that polycarbonate composition-3 (PC3) was used for the intermediate layer (the second layer), a sheet was formed and coated.

### Example 6

The reflection surface of a sheet formed by the same method as that of Example 1 was coated with light resistant coating agent 3 to form a coating film of 10 μm thickness, and further the side (the outermost layer) opposite to the reflection surface was coated with coating agent 1 to form a coating film of 20 μm thickness.

### Example 7

Polycarbonate-based composition-1 (PC1 pellet) and polycarbonate composition-4 (PC4 pellet) were dried in a hot air oven at 140° C. for 4 hr. The resultant materials were coextruded as two layers with two kinds in the horizontal direction by using individual extruding apparatuses having a 65 mmΦ-single axis extruder equipped with a vapor-removing unit for polycarbonate-based composition-1 or a 30 mmΦ-single axis extruder equipped with a vapor-removing unit for polycarbonate-based composition-4, a feed block and a coat hanger die of 60 cm width, and then the extruded material was sheet-formed with a longitudinal three chill-roll system to obtain a sheet of the total thickness of 800 μm consisting of a polycarbonate-based composition-1 layer of 600 μm thickness and a polycarbonate-based composition-4 layer of 200 μm thickness.

Here, the cylinder temperature was 250 to 260° C., the vapor-removing pressure was 1.3 kPa (10 mmHg), the die temperature was 260° C., the temperatures of the roll No. 1, No. 2 and No. 3 were 120° C., 150° C. and 170° C., respectively, and the extrusion amount was 35 kg/hi for polycarbonate-based composition-1 and 15 kg/hr for polycarbonate-based composition-4.

### Example 8

This example was carried out according to Example 1 except that a foamed PET film, trade name “Lumiror E60L” produced by Toray Industries, Inc., was used with a thickness of 200 μm as the first layer in the multilayer configuration.

### Example 9

This example was carried out according to Example 1 except that a supercritical foamed PET film, trade name “RA” produced by The Furukawa Electric Co., Ltd., was used with a thickness of 200 μm as the first layer in the multilayer configuration.

### Example 10

This example was carried out according to Example 1 except that a foamed PP film, trade name “White Refstar” produced by Mitsui Chemicals Inc., was used with a thickness of 200 μm as the first layer in the multilayer configuration.

### Comparative Example 1

Polycarbonate-based composition-1 (PC-1 pellet) was dried in a hot air oven at 140° C. for 4 hr. The resultant material was extruded in the horizontal direction using an extruding apparatus having a 65 mmΦ-single axis extruder equipped with a vapor-removing unit, a gear pump and a coat hanger die of 60 cm width, and then the extruded material was sheet-formed with a longitudinal three chill-roll system to obtain a sheet having a thickness of 0.6 mm.

Here, the cylinder temperature was 250 to 260° C., the vapor-removing pressure was 1.3 kPa (10 mmHg), the die temperature was 210° C., the temperatures of the roll No. 1, No. 2 and No. 3 were 120° C., 150° C. and 170° C., respectively, and the extrusion amount was 30 kg/hr. No light shielding coating layer was provided.

### Comparative Example 2

By the same method as that of Comparative Example 1, a sheet was prepared using polycarbonate-based resin compositions (PC2 pellet).

### Comparative Example 3

By the same method as that of Example 5, a laminated sheet was prepared but the light shielding coating layer was not provided.

The light shielding sheets obtained by the above-mentioned examples and comparative examples were evaluated by the following methods. The results are shown in Table 1.

### <Total Light Reflectance: Y Value>

Y value means a stimulus value Y in determining three stimulus values, X, Y and Z with respect to color of a sample (molded article) by spectro-colorimetry according to the methods described in JIS K 7105 and corresponds to the brightness ratio or luminous reflectance. The reflectance in 400 to 700 nm including the specular reflection was measured by using MS2020 Plus manufactured by Macbeth Co., Ltd. under the condition of a D65 light source and a viewing angle of 10°.

### <Total Light Transmittance>

The total light transmittance, referred to the value determined according to the methods described in JIS K 7105, was measured by using SZ Sigma 90 manufactured by Nippon Denshoku Industries Co., Ltd.

### <Light Leakage Evaluation>

A fluorescent tube for liquid crystal display device was turned on and the reflection surface of the sheet was attached to the surface of the fluorescent tube. The presence or absence of transmitting light from the fluorescent tube was judged. Excellent: No leakage observed, Poor: Leakage observed

### [Table 1]

TABLE 1

| | | | | | | | | | Light |
|---|---|---|---|---|---|---|---|---|---|
| | | | | | | | Total light | | leakage of |
| | Light | | | | | Total light | reflectance | Total light | fluorescent |
| | resistant | | Second | | Outermost | reflectance | of the | transmittance | tube |
| | coat layer | First layer | layer | Third layer | layer | of the first | outermost | of laminated | (Light |
| | Thickness | Thickness | Thickness | Thickness | Thickness | layer | layer | sheet | shielding |
| | (μm) | (μm) | (μm) | (μm) | (μm) | (%) | (%) | (%) | ability) |
| Example 1 | — | PC1 | — | — | Coat 1 | 98.5 | 7 | <0.1 | Excellent |
| | | 800 | | | 20 | | | | |
| Example 2 | — | PC1 | PC2 | — | Coat 1 | 98.5 | 7 | <0.1 | Excellent |
| | | 100 | 700 | | 20 | | | | |
| Example 3 | — | PC1 | PC2 | PC1 | Coat 1 | 98.5 | 7 | <0.1 | Excellent |
| | | 200 | 400 | 200 | 20 | | | | |
| Example 4 | — | PC2 | — | — | Coat 2 | 97.0 | 10 | 0.2 | Excellent |
| | | 800 | | | 10 | | | | |
| Example 5 | | PC1 | PC3 | PC1 | Coat 1 | 98.5 | 7 | 0.2 | Excellent |
| | | 200 | 400 | 200 | 20 | | | | |
| Example 6 | Coat 3 | PC1 | — | — | Coat 1 | 98.7 | 7 | <0.1 | Excellent |
| | 10 | 800 | | | 20 | | | | |
| Example 7 | — | PC1 | — | — | PC4 | 98.5 | 19 | 0.2 | Excellent |
| | | 600 | | | 200 | | | | |
| Example 8 | — | PET*1 | Coat 4 | PC3 | Coat 1 | 98.0 | 7 | ≦0.3 | Excellent |
| | | 200 | 10 | 400 | 20 | | | | |
| Example 9 | — | PET*2 | — | — | Coat 1 | 99.9 | 7 | ≦0.3 | Excellent |
| | | 1000 | | | 20 | | | | |
| Example 10 | — | PP*3 | Coat 4 | PC3 | Coat 1 | 99.5 | 7 | ≦0.3 | Excellent |
| | | 200 | 10 | 400 | 20 | | | | |
| Comparative | — | PC1 | — | — | — | 98.5 | — | 0.4 | Poor |
| Example 1 | | 800 | | | | | | | |
| Comparative | — | PC2 | — | — | — | 97.0 | — | 0.5 | Poor |
| Example 2 | | 800 | | | | | | | |
| Comparative | — | PC1 | PC3 | PC1 | — | 98.5 | — | 0.4 | Poor |
| Example 3 | | 200 | 400 | 200 | | | | | |

*1Foamed PET film, trade name “Lumiror E60L” produced by Toray Industries, Inc.
*2Supercritical foamed PET film, trade name “RA” produced by The Furukawa Electric Co., Ltd.
*3Foamed PP film, trade name “White Refstar” produced by Mitsui Chemicals Inc.

### Example 11

The sheet of Example 1 was dried at 100° C. for 8 hr and then provided with bent grooves of 2 mm wide and 1 mm deep by press forming at 140° C. The bent grooves were bent to form a box as a reflector of a 15-inch (dimensions: 23.4×30.7 cm) direct-underlying-type backlight, and the overlapped part of the sheet was bonded by ultrasonic adhesion (conditions: 28.5 kHz, oscillation time 0.08 sec) with a bond size of 5 mm in diameter. As the test, when six cold cathode fluorescent tubes were put in parallel inside the backlight and turned on, no light leakage was observed from the side or the opposite surface. In addition, when a light diffusion plate having a thickness of 2 mm was mounted on the backlight, an average luminance larger than 500 cd/cm² was found to be obtained. These results indicate that there can be produced a sheet which is sufficient for practical use as a backlight for a liquid crystal display.

The sheet of Example 1 was dried at 100° C. for 8 hr and then provided with bent grooves of 2 mm wide and 1 mm deep by press forming at 140° C. The bent grooves were bent to form a box, and two cold cathode fluorescent tubes were provided along the longer edge of a 15-inch sized acrylate-made optical waveguide (dimensions: 23.4 cm×30.7 cm, thickness: 4 mm). Further, the edges of the box were bent so as to cover the upper parts of the cold cathode fluorescent tubes, and the overlapped part of the sheet optical waveguide was bonded by ultrasonic adhesion (conditions: 28.5 kHz, oscillation time 0.08 sec) with a bond size of 5 mm in diameter. When the cold cathode fluorescent tubes were turned on, no light leakage was observed from the side or bottom, and an average luminance larger than 300 cd/cm² was found to be obtained. These results indicate that there can be produced a sheet which is sufficient for practical use as a backlight for a liquid crystal display.

### INDUSTRIAL APPLICABILITY

The light shielding highly reflective sheet of the present invention can be effectively applied to a product in which the reflection and the shielding of light emitted from a light source are concurrently required, such as a display of a liquid crystal display backlight or the like, a general lighting apparatus, a fluorescent tube used in housing, building facilities and the like, LED, EL, plasma, laser and the like.

1: A light shielding highly reflective laminated sheet which is a multilayer sheet comprising at least two layers, wherein the total light reflectance (Y value) of the surface of a first layer is 96% or more, the total light reflectance (Y value) of the surface of the outermost layer opposite to the first layer in said multilayer sheet is 30% or less and the total light transmittance of the laminated sheet is 0.3% or less.

2: The light shielding highly reflective laminated sheet according to claim 1, wherein the first layer comprises a resin composition containing a polycarbonate-based polymer and titanium oxide.

3: The light shielding highly reflective laminated sheet according to claim 2, wherein the polycarbonate-based polymer and titanium oxide are contained at the mass ratio of 50:50 to 92:8.

4: The light shielding highly reflective laminated sheet according to claim 1, wherein when a reflective layer is referred to as the first layer in the multilayer sheet, which comprises three or more layers, the total light reflectance (Y value) of the second layer is 80% or more.

5: A light shielding highly reflective laminated sheet, wherein at least one layer of the second layer and layer(s) thereunder comprises a composition containing a recycled material of the first layer or a recycled material of the multilayer highly reflective sheet according to claim 1.

6: The light shielding highly reflective laminated sheet according to claim 1, wherein the outermost layer opposite to the first layer is a light shielding coating layer with a black paint.

7: The light shielding highly reflective laminated sheet according to claim 1, wherein the surface of the first layer is provided with light resistant coating.

8: The light shielding highly reflective laminated sheet according to claim 1, wherein the first layer is a foamed body.

9: The light shielding highly reflective laminated sheet according to claim 1, which has hinge part(s) for bending.

10: A thermomolded article formed by using the light shielding highly reflective laminated sheet according to claim 1.

11: A case which is assembled by using the light shielding highly reflective laminated sheet according to claim 9 with the use of its bending hinge parts, wherein said light shielding highly reflective laminated sheet is adhered to another molded article of a thermoplastic resin or the light shielding highly reflective laminated sheets are adhered together.
